(19) United States
(12) Patent Application Publication
(10) Pub. No.: US 2026/0192806 A1
(43) Pub. Date: Jul. 9, 2026

(54) METHOD AND CONTROL SYSTEM FOR OPERATING A VEHICLE

(71) Applicant: VOLKSWAGEN AKTIENGESELLSCHAFT, Wolfsburg (DE)

(72) Inventors: Jonas KASTE, Alfeld (DE); Felix STAHL, Braunschweig (DE); Daniel Münning, Braunschweig (DE)

(21) Appl. No.: 19/457,919

(22) Filed: Jan. 23, 2026

(30) Foreign Application Priority Data
Jan. 7, 2025 (DE) 10 2025 100 281.9

(51) Int. Cl. B60W 40/08; G06V 10/82; G06V 20/59

(52) U.S. Cl. CPC B60W 40/08; G06V 10/82; G06V 20/597

(57) ABSTRACT

A computer-implemented method for operating a vehicle includes capturing an interior of the vehicle by optical sensors, capturing a condition of the vehicle by vehicle sensors, mapping optical data determined by the optical sensors and vehicle data determined by the vehicle sensors to indicators by an artificial neural network, wherein the indicators indicate at least a probability of a correct grip of a driver of the vehicle on the steering wheel of the vehicle, outputting the plurality of indicators, controlling the vehicle depending on the indicators output, wherein the artificial neural network is semantically divided into at least a first section and a second section, and wherein in the first section only the optical data are processed and in the second section data provided by the first section are processed together with the vehicle data.

### PRIORITY CLAIM

This patent application claims priority to German Patent Application No. 10 2025 100 281.9, filed 7 January 2025, the disclosure of which is incorporated herein by reference in its entirety.

### SUMMARY

Disclosed embodiments relate to a method for operating a vehicle, a control system for operating a vehicle, a vehicle, and a program product that provide a way to reliably detect a so-called "hand-off state", in which a driver has taken their hands off the steering wheel while driving, even without a capacitive sensor on the steering wheel.

### BRIEF DESCRIPTION OF THE DRAWINGS

Disclosed embodiments will be described with reference to the figures. The features and feature combinations in the description, as well as the features and feature combinations presented in the figures, may be used not only in the combination respectively indicated but also in other combinations or individually, without departing from the scope of the disclosure. In the drawings:

FIG. 1 schematically shows a possible design of the presented method;

FIG. 2 schematically shows a detailed representation of the method according to FIG. 1;

FIG. 3 schematically shows different network architectures for carrying out the method according to FIG. 1; and

FIG. 4 schematically shows a possible design of a vehicle with a possible design of the presented control system.

### DETAILED DESCRIPTION

In many production vehicles, for monitoring driver activity sensors such as a capacitive steering wheel are used to detect the driver touching the steering wheel, for example, with two or three fingers, and to transfer these control functions, for example, to a control assistance system.

The touch of the hands on the steering wheel indicates a driver's activity and thus their attention. For example, the driver is advised to put their hands on the steering wheel if their hands were not on the steering wheel for a certain time during lateral guidance.

So-called Level 2 systems, or the safety concept thereof, are based on the driver having his hands on the steering wheel at all times. Accordingly, hands-free travel is currently not part of the Level 2 system.

In the assistance system of a Level 2 system, driver activity is monitored with the help of a capacitive steering wheel and/or the measurement of the driver's steering torque. So far, simply observing the steering torque has not been sufficient to reliably monitor the driver's activity, as for example, when driving on the motorway a driver does not always apply enough torque, for example, > 0.7Nm, to the steering wheel to trigger positive driver activity detection. For this reason, Level 2systems are usually only installed with a capacitive steering wheel.

One limit of steering torque-based detections is the differentiation of grip variations. The approach can recognize a so-called "hands-on situation" with sufficient torque, but cannot differentiate whether, for example, one or two hands were used to apply the torque. The position of the hands on the steering wheel cannot be determined using a steering torque-based approach either. Another problem is the detection of operating errors, for example, when objects on the steering wheel apply a large interference torque.

DE 102022 109950 A1, CN 116985893 A and US 2022 016846 A1 each describe a method and a device for determining a state in which a driver's hand is in a predetermined position relative to a steering wheel. For this purpose, steering angle data and steering torque data of the steering wheel are evaluated by a machine learner and assigned to one of three states.

Within the framework of the present disclosure, a method and a control system for operating a vehicle as well as a vehicle and a program product are presented. Further features and details can be found in the description and the drawings. In this context, features and details described in connection with the method according to the disclosed embodiments naturally also apply in connection with the control system and the vehicle or the program product and vice versa in each case, so that mutual references regarding the disclosure can always be or are made for the individual aspects of the disclosed embodiments.

Against this background, disclosed embodiments provide a way to reliably detect a so-called "hand-off state", in which a driver has taken their hands off the steering wheel while driving, even without a capacitive sensor on the steering wheel.

Thus, a computer-implemented method for operating a vehicle is presented.

The presented method includes the capture of an interior of the vehicle by a plurality of optical sensors, the capture of a condition of the vehicle by a plurality of vehicle sensors, and the assignment of optical data determined by the plurality of optical sensors and vehicle data determined by the plurality of vehicle sensors to a plurality of indicators by an artificial neural network, wherein the plurality of indicators indicates at least a probability of the correct grip of a driver of the vehicle on the steering wheel of the vehicle.

Furthermore, the presented method includes the output of the plurality of indicators and control of the vehicle depending on the plurality of indicators output, wherein the artificial neural network is semantically divided into at least a first section and a second section, wherein in the first section only the optical data are processed and in the second section data provided by the first section are processed together with the vehicle data.

Disclosed embodiments are based on a deep fusion of data within an artificial neural network to process sensor data from different sensors together. The joint processing of the various sensor data enables the detection of a hands-on situation, i.e., a situation in which a driver of a vehicle has a correct grip on the steering wheel of the vehicle, or a hands-off situation in which the driver does not have a correct grip on the steering wheel of the vehicle.

In particular, the presented method enables the detection of a correct grip in a robust manner, especially robust against incorrect operation. Due to the fusion or joint processing of the different sensor data, for example, image data or optical data and vehicle data of, for example, an accelerometer, incorrect operation caused by, for example, weights on the steering wheel or a false grip can be reliably detected and distinguished from a correct grip.

According to the disclosed embodiments , an artificial neural network is used, which is semantically divided into two sections and processes different input information in the different sections.

In the first section, image processing is carried out. This part of the network receives image data, such as raw images or compressed images from an optical sensor, such as an interior camera of the vehicle.

The aim of the first section is to provide image-based, i.e., based on optical sensor data, probabilities for a state such as hands-on/hands-off, grip type, incorrect operation, and/or respective uncertainty values in the form of abstractly derived features.

These features are provided as input variables for the second section and are combined with further vehicle data, such as steering variables, driving dynamics variables and ADAS variables.

In the second section, deeper processing takes place, the so-called "deep fusion", in which the features provided by the first section from the optical data and the additional vehicle data are processed together in order to extract the respective desired information and to output the probabilities for hands on/hands off, grip type, incorrect operation and/or corresponding uncertainty factors.

Based on the probabilities output, the vehicle can be steered, for example, a warning message is issued that alerts the driver to an incorrect grip and/or an assistance system of the vehicle is deactivated, if appropriate using a so-called "dead time" or a countdown.

The advantage of the presented method is that the weaknesses of exclusively steering torque-based approaches and exclusively image-based approaches are compensated. Depending on the installation position, an interior camera cannot resolve the entire steering wheel rim or can have weaknesses in differentiating between whether the driver's hands are only near the steering wheel or whether they are actually touching it or gripping it correctly.

Due to the joint processing or fusion of the optical data and the vehicle data by the artificial neural network provided according to the disclosed embodiments , it is possible to use vehicle data, for example, torque changes applied to the steering wheel, to clearly detect whether the driver's hands are on the steering wheel or whether the driver is in a hands-off situation or a hands-on situation.

At the same time, the optical sensor, which for example, can be a camera, can distinguish between different grips, such as a one-hand grip or a two-hand grip.

Incorrect operation can also be reliably detected using the method presented, since if both hands are detected as not being near the steering wheel based on the optical data, but a hands-on situation is still permanently reported based on vehicle data, especially steering torque-based data, an error bit or a warning message can be output or the corresponding assistance system can be switched off.

Due to the separation of the artificial neural network into the first section for the pre-processing of the optical data and the second section for the fusion of the optical data pre-processed by the first section with the respective vehicle data, the first section can be adapted independently of the second section, for example, trained. Accordingly, the first section can, for example, be adapted to optical conditions, in particular an orientation and/or a type of the plurality of optical sensors, without having to change the second section. Therefore, the artificial neural network can be adjusted particularly quickly to different types of vehicle, for example.

For example, the processing of the optical data and/or the vehicle data can be carried out in a so-called "multihead architecture" of the artificial neural network, in which information from the optical data, the optical data, and the vehicle data or only the vehicle data are provided for later plausibility checks.

It may be envisaged that the plurality of parameters will continue to include: a probability of an incorrect grip of the driver on the steering wheel, a probability of incorrect operation, and at least one uncertainty factor.

An incorrect grip of the driver on the steering wheel, for example, a hands-off situation or a grip that for example, does not correspond to a predetermined pose, can lead to controlling the vehicle, in particular to outputting a warning message indicating to the driver that the grip is not correct.

It can also be provided that the first section of each pixel and a plurality of color channels of the plurality of optical sensors are processed as input values, and the first section consists of an amalgamation of convolutional layers and max pooling layers, by which the optical information is reduced to a plurality of feature vectors and the plurality of feature vectors is passed to the second section.

By merging convolutional layers and max pooling layers, a large amount of data is limited to a smaller plurality of relevant feature vectors that abstractly describe the amount of data. For this purpose, the plurality of relevant feature vectors can be predetermined or dynamically determined.

It may also be envisaged that the second section consists of several recurrent layers, fully cross-linked layers and at least one output layer.

Recurrent layers, such as so-called long-short-term-memory (LSTM) layers, enable processing of the abstract feature vectors from the first section. For this purpose, the recurrent layers can be trained accordingly by a training program.

Accordingly, it may also be envisaged that the artificial neural network is trained based on training data that have been assigned to a basic truth for a probability of a correct grip of the driver of the vehicle on the steering wheel of the vehicle by a capacitive sensor on the steering wheel of the vehicle.

By using a capacitive sensor on the steering wheel, an objective and correspondingly reliable basic truth can be determined, based on which, for example, respective training data can be labeled so that the artificial neural network provided according to the disclosed embodiments can test itself and adapt itself if necessary.

The training of the artificial neural network can be carried out, for example, by randomly initializing starting weights to perform a full training program or by carrying out transfer learning. For the first section of the network, existing weights of an existing image recognition network can be used as edge classifiers and only post-training can be carried out in combination with retraining of the last layers by hands-on data.

For post-processing, a weighting of the uncertainty can be used in the last operation of the training by an expert approach or a link of the outputs for the final hands-on information can be used. For example, in the event that there is a high probability of incorrect operation, the other information about hands-on/off and grip type can be evaluated differently than if incorrect operation is unlikely.

It can also be provided that a metalabel is assigned to the training data for a state in which there is an operating error.

To indicate incorrect operation, a metalabel can be used, which for example, is inserted by a user so that the operating errors are automatically detected as such during training and the artificial neural network can adapt accordingly.

It may also be provided that the plurality of indicators includes a probability for at least one state of the following list of states: light grip of the steering wheel, firm grip of the steering wheel, one hand on the steering wheel, two hands on the steering wheel, touching at least one specified zone of the steering wheel.

To detect different states, corresponding labels can be used during training, for example, automatically using a capacitive sensor and/or manually provided by a user.

It may also be envisaged that the vehicle data include at least one of the following list of variables: steering variables, vehicle dynamics variables, and ADAS variables.

Vehicle data from advanced driver assistance systems (ADAS) have proven to be particularly relevant as a complement to optical data in determining the probability of a driver of the vehicle correctly gripping the steering wheel of the vehicle.

It may also be envisaged that relevant image areas in the optical data are extracted by a bounding box method or by a region of interest and that only optical data captured in the relevant image areas are processed further.

By applying bounding-box methods or a region of interest, a quantity of optical data to be processed and, therefore, a computational load for carrying out the presented method can be limited.

It may also be provided that, in the event that the probability of the driver of the vehicle correctly gripping the steering wheel of the vehicle is below a predetermined threshold, a steering system of the vehicle will be switched to manual operation.

A second aspect of the presently disclosed embodiments relates to a control system for operating a vehicle.

The presented control system contains a computing unit that is configured to carry out a possible implementation of the presented method.

In the context of the presently disclosed embodiments, a computing unit is to be understood as a computer, in particular, a cloud computer, a processor, a control unit or any other programmable circuit.

A third aspect of the presently disclosed embodiments relates to a vehicle which contains a possible implementation of the presented control system.

Due to the presented control system, the vehicle can also be used for Level 2 operation without a capacitive sensor on the steering wheel, so that the presented vehicle is particularly cost-efficient.

A fourth aspect of the presently disclosed embodiments relates to a program product that contains program code that configure a computing unit to carry out a possible embodiment of the presented method when executed on the computing unit.

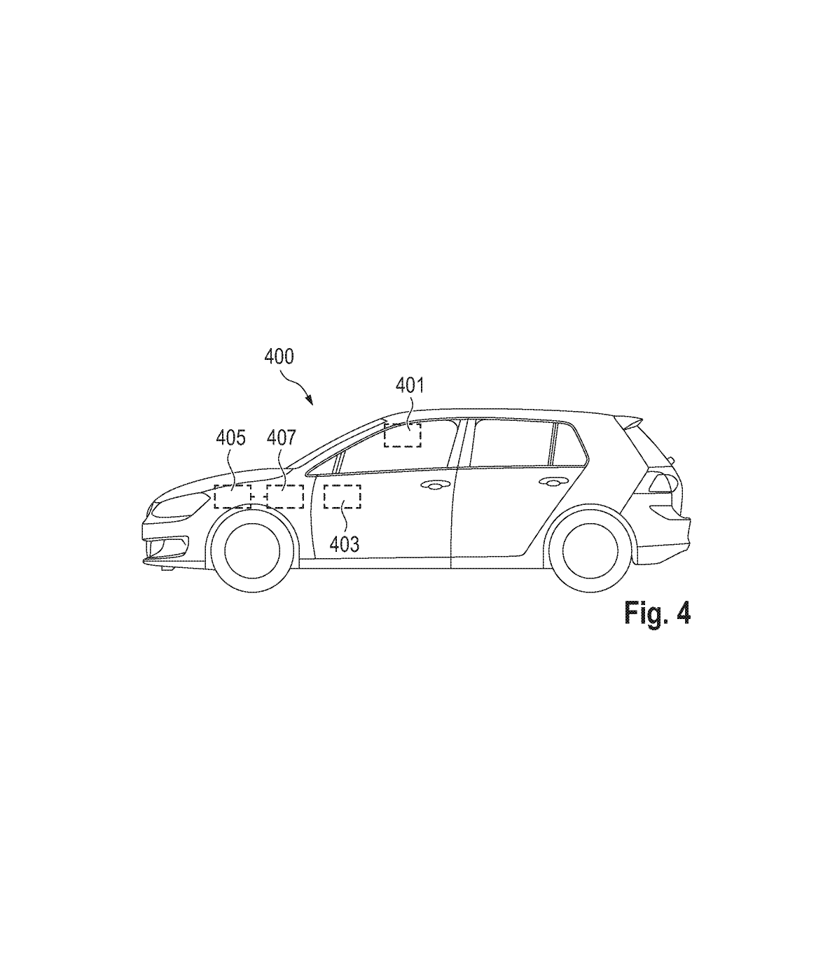

FIG. 1 shows a computer-implemented method 100 for operating a vehicle 400 shown in FIG. 4.

The method 100 includes a first detection operation 101, in which an interior of the vehicle 400 is captured by a plurality of optical sensors. Specifically, the plurality of optical sensors includes a camera 401, which captures a driver and a steering wheel of the vehicle 400.

Furthermore, the method 100 includes a second capture operation 103, in which a condition of the vehicle 400 is captured by a plurality of vehicle sensors 403. In particular, the plurality of vehicle sensors 403 includes an accelerometer, a steering angle sensor, a steering torque sensor, a steering speed sensor and/or a driver assistance system or a sensor on which a driver assistance system is based, such as a LIDAR.

Furthermore, the method 100 includes an assignment operation 105, in which optical data determined by the plurality of optical sensors and vehicle data determined by the plurality of vehicle sensors 403 are assigned to a plurality of indicators by an artificial neural network. The plurality of indicators indicates at least a probability of a correct grip by a driver of the vehicle on the steering wheel of the vehicle.

Furthermore, the method 100 includes an output operation 107, in which the plurality of indicators is output, and a control operation 109, in which the vehicle 400 is controlled depending on the plurality of indicators output.

The artificial neural network is semantically divided into at least a first section and a second section, wherein the first section processes only the optical data and the second section processes data provided by the first section together with the vehicle data.

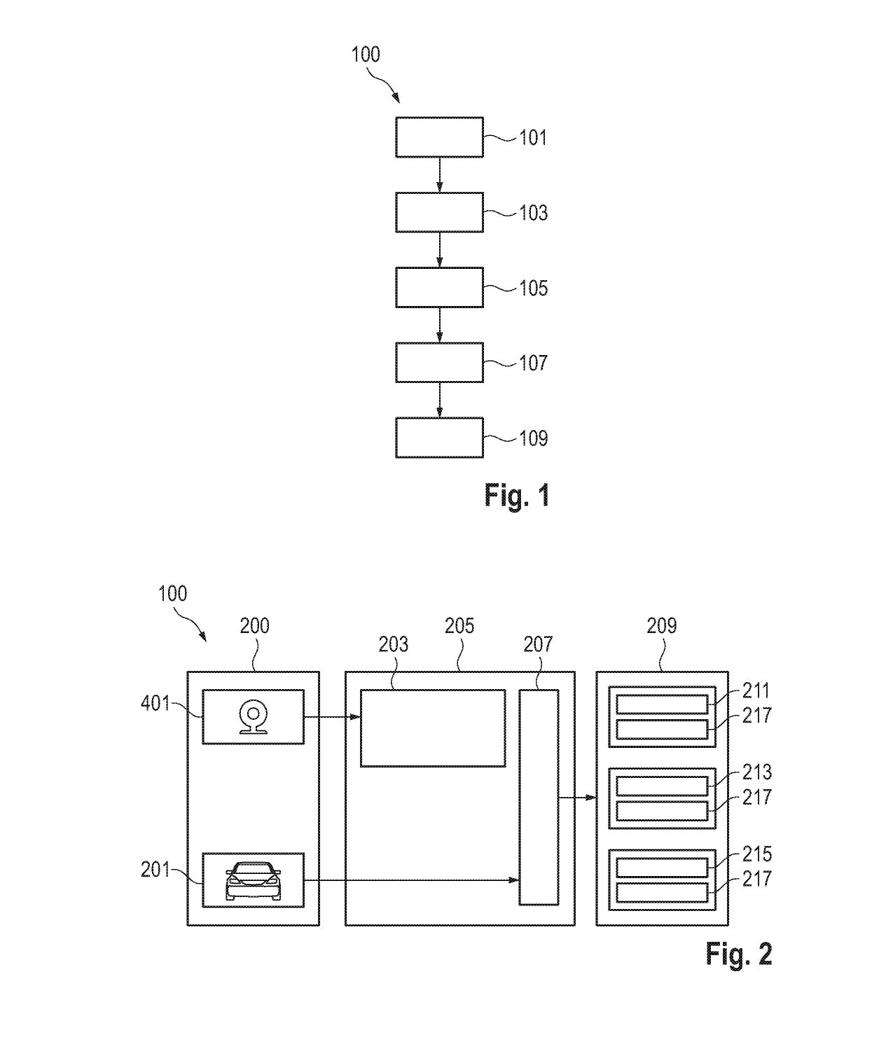

In FIG. 2 the method 100 is schematically illustrated. Using sensor sources 200 in the form of a camera 401, for example, and a steering torque sensor 201, for example, a condition of the vehicle and driver are captured. For this purpose, optical data determined by the camera 401 are processed in a first section 203 of an artificial neural network 205, i.e., combined into abstract features for example, and passed to a second section 207 of the artificial neural network 205.

In the second section 207, the data output by the first section 203 are processed together with the vehicle data determined by the steering torque sensor 201 and assigned to a plurality of indicators 209 that indicate a probability for the existence of predetermined situations, such as hands-on/hands-off 211, grip 213, and incorrect operation 215. Optionally, each indicator is assigned an uncertainty factor 217.

Based on the plurality of indicators 209, a condition of the driver can be assessed accordingly and the vehicle 400 can be controlled accordingly, for example, a warning message is output that reminds the driver to take a correct grip or a driver assistance system, for example, a Level 2 driver assistance system, is activated or deactivated.

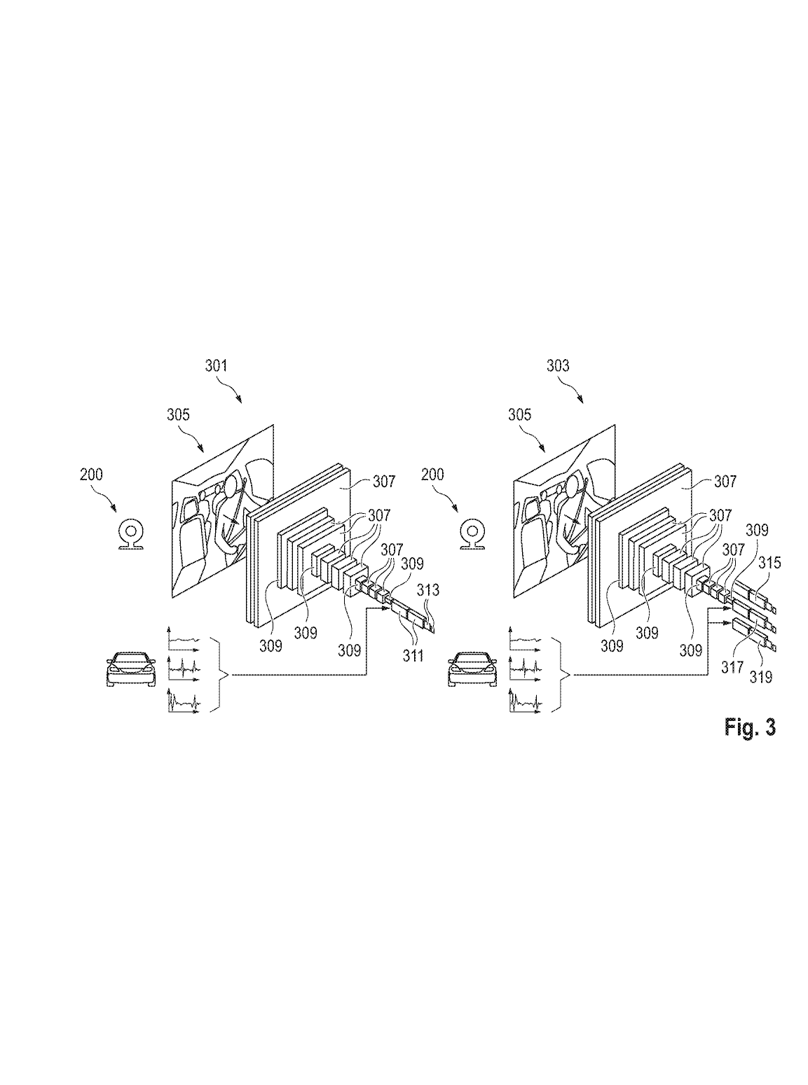

FIG. 3 shows a first network architecture 301 and a second architecture 303.

According to the first network architecture 301, data packets 305 provided by the sensor sources 200 are successively compressed and processed one after the other. For this purpose, convolutional layers 307, max pooling layers 309 and LSTM layers 311 and output layers 313 are envisaged, which are executed one after the other.

As an alternative to the first network architecture 301, the second network architecture 303 has parallel processing paths 315, 317 and 319, which provide a specific output in parallel by the respective LSTM layers and respective output layers. For this purpose, an image processing path 315, a driving data path 317 and a fusion path 319 are provided according to a so-called "multihead architecture," in which information from the optical data, the optical data and the vehicle data or just the vehicle data are provided.

FIG. 4 shows a vehicle 400. The vehicle 400 contains a control system 405, which in turn contains a computing unit 407 configured to carry out the method 100 as described in FIG. 1. For this purpose, the computing unit 407 receives input signals from a camera 401 and vehicle sensors 403.

### LIST OF REFERENCE SIGNS

100 Method

101 First capture operation

103 Second capture operation

105 Assignment operation

107 Output operation

109 Control operation

200 Sensor sources

201 Steering torque sensor

203 First section

205 Artificial neural network

207 Second section

209 Indicators

211 Hands-on/Hands-off

213 Handle

215 Incorrect operation

217 Uncertainty factor

301 First Network Architecture

303 Second Network Architecture

305 Data packet

307 Convolutional layer

309 Max pooling layer

311 LSTM layer

313 Output Layer

315 Image Processing Path

317 Driving data path

319 Fusion Path

400 Vehicle

401 Camera

403 Vehicle Sensors

405 Control System

407 Computing Unit

Patent claims:

1. A computer-implemented method for operating a vehicle, wherein the method comprises:
capturing an interior of the vehicle by a plurality of optical sensors;
capturing a condition of the vehicle by a plurality of vehicle sensors;
mapping optical data determined by the plurality of optical sensors and vehicle data determined by the plurality of vehicle sensors to a plurality of indicators by an artificial neural network, wherein the plurality of indicators indicates at least a probability of a driver of the vehicle correctly gripping the steering wheel of the vehicle;
outputting the plurality of indicators; and
controlling the vehicle depending on the plurality of indicators output,
wherein the artificial neural network is semantically divided into at least a first section and a second section, and
wherein in the first section only the optical data are processed and in the second section data provided by the first section are processed together with the vehicle data.

2. The method of claim 1, wherein the plurality of indicators also includes a probability of an incorrect grip of the driver on the steering wheel, a probability of incorrect operation, and at least one uncertainty factor.

3. The method of claim 1, wherein each pixel as well as a plurality of color channels of the plurality of optical sensors are processed as input values by the first section, and the first section includes a fusion of convolutional layers and max pooling layers, by which the optical information is reduced to a plurality of feature vectors and the plurality of feature vectors is passed to the second section.

4. The method of claim 1, wherein the second section includes several recurrent layers, fully cross-linked layers and at least one output layer.

5. The method of claim 1, wherein the artificial neural network is trained based on training data assigned by a capacitive sensor on the steering wheel to a basic truth for a probability of a correct grip of the driver of the vehicle on the steering wheel of the vehicle.

6. The method of claim 5, wherein, for a state in which there is an operating error, a metalabel is assigned to the training data.

7. The method of claim 1, wherein the plurality of indicators includes a probability for at least one state of the following list of states: light grip of the steering wheel, firm grip of the steering wheel, one hand on the steering wheel, two hands on the steering wheel, touching at least one predetermined zone of the steering wheel.

8. The method of claim 1, wherein the vehicle data include at least one variable of the following list of variables: steering variables, vehicle dynamics variables, ADAS variables.

9. The method of claim 1, wherein relevant image areas in the optical data are extracted by a bounding box method or by a region of interest and that only optical data captured in the relevant image areas are processed further.

10. The method of claim 1, wherein, in response to the probability of the driver of the vehicle correctly gripping the steering wheel of the vehicle being below a predetermined threshold value, a driver assistance system of the vehicle is switched to manual operation.

11. A control system for operating a vehicle, the control system comprising:
a plurality of optical sensors;
a plurality of vehicle sensors;
a computing unit;
an artificial neural network; and
a plurality of indicators,
wherein the computing unit configured to capture an interior of the vehicle by the plurality of optical sensors, capturing a condition of the vehicle by the plurality of vehicle sensors, mapping optical data determined by the plurality of optical sensors and vehicle data determined by the plurality of vehicle sensors to the plurality of indicators by the artificial neural network, wherein the plurality of indicators indicates at least a probability of a driver of the vehicle correctly gripping the steering wheel of the vehicle, outputting the plurality of indicators, and controlling the vehicle depending on the plurality of indicators output,
wherein the artificial neural network is semantically divided into at least a first section and a second section, and
wherein in the first section only the optical data are processed and in the second section data provided by the first section are processed together with the vehicle data.

12. The control system of claim 11, wherein the plurality of indicators also includes a probability of an incorrect grip of the driver on the steering wheel, a probability of incorrect operation, and at least one uncertainty factor.

13. The control system of claim 11, wherein each pixel as well as a plurality of color channels of the plurality of optical sensors are processed as input values by the first section, and the first section includes a fusion of convolutional layersand max pooling layers, by which the optical information is reduced to a plurality of feature vectors and the plurality of feature vectors is passed to the second section.

14. The control system of claim 11, wherein the second section includes several recurrent layers, fully cross-linked layers and at least one output layer.

15. The control system of claim 11, wherein the artificial neural network is trained based on training data assigned by a capacitive sensor on the steering wheel to a basic truth for a probability of a correct grip of the driver of the vehicle on the steering wheel of the vehicle.

16. The method of claim 15, wherein, for a state in which there is an operating error, a metalabel is assigned to the training data.

17. The control system of claim 11, wherein the plurality of indicators includes a probability for at least one state of the following list of states: light grip of the steering wheel, firm grip of the steering wheel, one hand on the steering wheel, two hands on the steering wheel, touching at least one predetermined zone of the steering wheel.

18. The control system of claim 11, wherein the vehicle data include at least one variable of the following list of variables: steering variables, vehicle dynamics variables, ADAS variables.

19. The control system of claim 11, wherein relevant image areas in the optical data are extracted by a bounding box method or by a region of interest and that only optical data captured in the relevant image areas are processed further.

20. The control system of claim 11, wherein, in response to the probability of the driver of the vehicle correctly gripping the steering wheel of the vehicle being below a predetermined threshold value, a driver assistance system of the vehicle is switched to manual operation.

21. A vehicle containing the control system of claim 11.

22. A non-transitory computer readable medium including program code which configures a computing unit to carry out the method of claim 1 when executed on the computing unit.
